(19) United States
(12) Patent Application Publication
(10) Pub. No.: US 2007/0160209 A1
(43) Pub. Date: Jul. 12, 2007

(54) Content management method, content management program, and electronic device

(75) Inventors: Akihiro Kasahara, Chiba (JP); Akira Mura, Kanagawa (JP); Hiroshi Suu, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/571,365

(22) PCT Filed: Jun. 8, 2005
(86) PCT No.: PCT/JP05/10480

§ 371 Date: Jan. 19, 2007

(30) Foreign Application Priority Data
Jul. 2, 2004 (JP) 2004-196933

(51) Int. Cl. H04N 7/167

(52) U.S. Cl. 380/217

(57) ABSTRACT

Data in a storage medium not using an encryption double key scheme is transferred to a storage medium using an encryption double key scheme. A title key Kt encrypting content data C in an SD audio card SDa is further encrypted by a user key Kua generated in a key generating unit 23e, and is stored in a user data area 4 in an SD card SDq. The generated user key Kua is encrypted by a medium unique key Kmuq in the SD card SDq, and is stored in a protection area 3.

### FIELD OF THE INVENTION

The present invention relates to an electronic instrument connectable to a storage medium conforming to an encryption double key scheme, and a content data management method or a program for shifting stored data of a storage medium in such an electronic instrument or the like.

### BACKGROUND OF THE INVENTION

In recent years, with development of information society, a content data distribution system is widely used. In this system, the content data including an electronic data such as a book, newspaper, music, or moving pictures, is distributed to a user terminal, which enables browsing of a content data in the user terminal.

However, since electric content data (heretofore, it is referred to as “content data”) can be copied easily, the electronic content data tends to induce illegal acts that disregard copyright. From a viewpoint of protecting content data from such an illegal act, a content data is encrypted and recorded by the encryption key and is usually decoded at the time of reproducing.

Content data protection technologies like this include CPRM (Content Protection for Prerecorded Media) which uses a standardized encryption key scheme in SD audio, SD video, SD E-e-Publish (SD computer-assisted publishing) or the like (for example, refer to Nonpatent Literature 1).

FIG. 7 is a schematic diagram showing the configuration of the SD card and a user terminal conforming to the encryption double key scheme. A SD card SDa is an example of a secure storage medium which securely stores data. The SD card SDa has a system area 1′, a hidden area 2′, a protected area 3′, a user data area 4′, and an encryption/decryption unit 5′. The data is stored in each area 1-4 according to the SD audio standard. The subscript “a” of the SD card SDa represents that it conforms to an SD audio standard. It is not limited to this but it also conforms to all SD monomedia standards defined at present such as SD video standard and an SD e-publish standard.

Specifically, in an SD card SDq like this, key management information MKB (Media Key Block) and the medium identifier IDm are stored in the system area 1′. A medium unique key Kmu is stored in the hidden area 2. The encrypted title key Enc (Kmu, Kt) is stored in the protection area 3′. An encrypted content data Enc (Kt, C) is stored in the user data area 4′. The expression of Enc (A, B) means the data B encrypted with data A in this specification.

Here, the system area 1′ is a read-only area which can be accessed from outside of the SD card. The hidden area 2′ is a read-only area that the SD card itself refers to, and cannot be accessed at all from external. The protection area 3′ is an area in which data read and write is possible from external of the SD card when authentication is accomplished.

The user data area 4′ is an area in which read/writing is freely possible from outside of the SD card. The encryption/decryption unit 5′ performs authentication, key exchanging, and cryptography, and has a function of encryption/decryption.

The user terminal 10a for reproducing operates logically as follows to such the SD card SDa. That is, the user terminal 10a, performs MKB processing of the key management information MKB read from the system area 1′ of the SD card SDa with the device key Kd set up beforehand (ST1), to obtain a medium key Km. Next, the user terminal 10a carries out the hash processing of both the medium key Km and the medium identifier IDm read from the system area 1′ of the SD card SDa (ST2), and obtains the medium unique key Kmu.

Thereafter, the user terminal 10a performs, based on the medium unique key Kmu, an authentication process and a key exchanging process (AKE: Authentication Key Exchange) with the decryption/encryption unit 5′ of the SD card SDa, to share a session key with the SD card SDa (ST3).

Note that the authentication and key exchanging process in the step ST3 succeeds when the medium unique key Kmu in the hidden area 2′ referred to at the decryption/encryption unit 5′ coincides with the medium unique key Kmu generated by the user terminal 10a, thereby the session key Ks being shared.

Then, the user terminal 10a reads out the encrypted title key Enc (Kmu, Kt) from the protection area 3′, through a cipher communication using the session key Ks (ST4). This results in the encrypted title key Enc (Kmu, Kt) being decrypted by the medium unique key Kmu (ST5). Then, the title key Kt will be obtained.

Finally, when the encrypted content data Enc (Kt, C) is read from the user data area 4′ of the SD card SDa, the user terminal 10a carries out the decryption processing of the encrypted content data Enc (Kt, C) with the title key Kt to reproduce content data C obtained (ST5q). In the encryption key scheme described above, a title key Kt is encrypted by a medium unique key Kum (singly).

On the other hand, the encryption double key scheme in which the content key is doubly encrypted with the user key (=title key Kt) and the medium unique key is known (for example, refer to nonpatent literature 2). This kind of encryption double key scheme is used in MQbic (registered trademark), for example.

FIG. 8 is a diagram showing the configuration of the SD card and a user terminal corresponding to the encryption double key scheme. This mainly differs from FIG. 7 by following three-point (i)-(iii).
(i) In the protection area 3, instead of an encrypted title key, an encrypted user key Enc (Kmu, Ku) is stored. Note that the user key Ku is encryption/decryption key to the content key Kc, and is used in common also to two or more encrypted content keys Enc (Ku, Kc1), Enc (Ku, Kc2) . . . in the same SD card SDq. The subscript q of the SD card SDq expresses that it conforms to MQbic (registered trademark).
(ii) In the user data area 4, instead of encrypted content data, encrypted content key Enc (Ku, Kc) is stored. On the other hand, encrypted content data is stored in the memory 11q in the user terminal 10q it may be stored in the external storage medium. (iii) It performs a decryption process (ST5q) for decoding an encrypted content key and obtaining the content key (=title key) Kc between steps ST5 and ST6, based on a decryption result (user key Ku) with the medium unique key Kmu.

According to the three differences, although the SD card SDq and the user terminal 10q in FIG. 8 operate as steps ST1-ST3 of FIG. 9, they operate as follows after step ST4.

The user terminal 10q reads out the encrypted user key Enc (Kmu, Ku) from the protection area 3, through a cipher communication using the session key Ks (ST4). This results in the encrypted user key Enc (Kmu, Ku) being decrypted by the medium unique key Kmu (ST5). Then, the user key Ku will be obtained.

Furthermore, when the encrypted content key Enc (Ku, Kc) is read from the user data area 4 of the SD card SDq, the user terminal 10q carries out the decryption processing of the encrypted content key Enc (Ku, Kc) with the user key Ku to obtain a content key Kc(ST5q).

Finally, when the encrypted content data Enc (Kc, C) is read from Memory 11q, the user terminal 10q performs the decryption processing of the encrypted content data Enc (Kc, C) with the content key Kc (ST6). Thereby, the user terminal 10q reproduces the obtained content data C.

The above-mentioned encryption double key scheme stores encrypted content key data at the user data area 4 having a large memory capacitance compared to the protection area 3. Therefore, it has an advantage in that it can store a lot of encrypted content key data compared to encryption single key scheme.

Moreover, since the encryption double key scheme may store encrypted content data in the SD card, it may urge the distribution of an encrypted content data.
[Nonpatent literature 1] 0 4C An entity, LLC, [online] Internet <URL: http://www.4Centity.com/, searched on Jun. 14, 2004>
[Nonpatent literature 2] IT information site and ITmedia news [online], Internet<URL:http://www.itmedia.co.jp/news/0307/18/njbt_{—}02.html, searched on Jun. 14, 2004>

### [Disclosure of the Invention]

### [Problem to be Solved]

In the user terminal 10q conforming to the above-described encryption double key scheme, a storage medium used in an encryption single key scheme as another scheme cannot be reproduced, because of a difference in encryption method.

Therefore, users want to utilize these content data distributed under different kinds of right-protection scheme in the same way.

### SUMMARY OF THE INVENTION

A content data management method according to the present invention is used in a storage medium processing system using a first storage medium and a user terminal. The first storage medium stores medium identifier data, medium unique key data enabled to be generated based on the medium identifier data, encrypted user key data in which user key data is encrypted so that it may be decrypted using the medium unique key data, and first content key data in which content key data is encrypted so that it may be decrypted using the user key data.

The user terminal retains in a memory unit encrypted first content data so that it may be decrypted using the first content key data. The system is configured to protect a right of the first content data by an encryption scheme using the user key and the content key. The method is for commonly utilizing data stored in a second storage medium retaining second content data delivered in a right protection scheme different from that of the first content data. The method comprises: a write step writing in the memory unit of the user terminal or the first storage medium the second content data encrypted with a first key data; a step generating second key data for encrypting the first key data; and a memory step encrypting the first key data with the second key data to storing it in the first storage medium.

A content data management program according to the invention is used in a storage medium processing system using a first storage medium and a user terminal. The first storage medium stores medium identifier data, medium unique key data enabled to be generated based on the medium identifier data, encrypted user key data in which user key data is encrypted so that it may be decrypted using the medium unique key data, and first content key data in which content key data is encrypted so that it may be decrypted using the user key data.

The user terminal retains in a memory unit encrypted first content data so that it may be decrypted using the first content key data. The system is configured to protect a right of the first content data by an encryption scheme using the user key and the content key. The method is for commonly utilizing data stored in a second storage medium retaining second content data delivered in a right protection scheme different from that of the first content data. The program is configured to perform: a write step writing in the memory unit of the user terminal or the first storage medium the second content data encrypted with a first key data; a step generating second key data for encrypting the first key data; and a memory step encrypting the first key data with the second key data to storing it in the first storage medium.

An electronic device according to the present invention is enabled to be connected to a first storage medium storing medium identifier data, medium unique key data enabled to be generated based on the medium identifier data, encrypted user key data in which user key data is encrypted so that it may be decrypted using the medium unique key data, and first content key data in which content key data is encrypted so that it may be decrypted using the user key data, and storing in a memory unit encrypted first content data so that it may be decrypted using the first content key data. The device is configured to be connected to a second storage medium retaining second content data delivered in a right protection scheme different from that of the first content data, and shift data stored in the second storage medium to the first storage medium. The device comprises: a key generating unit generating a second key data for encrypting a first key data encrypting the second content data; an encryption unit encrypting the first key data with the second key data; and a read/write unit writing the second content data encrypted with the first key data in the memory unit or in the first storage medium, and writing the first key data encrypted in the encryption unit in the first storage medium.

### The Advantage of the Invention

According to this invention, the second key data for further encrypting the first key data encrypting the second content data in the second storage medium is generated, the first key data is encrypted by the second key data, and is stored in the first storage medium. By generating the second key data, data in the second storage medium not conforming to an encryption double key scheme may be stored in the first storage medium. Thereby, content data that is stored in a card using a conventional encryption scheme may be utilized.

### EMBODIMENTS

Hereafter, embodiments of the present invention will now be described with reference to the drawings.

FIG. 1 is a diagram showing the configuration of the storage medium processing system concerning the embodiment of the present invention. The same numerals are given to the same parts as FIG. 7 and 8, and detailed explanation is omitted for these parts. Different parts are hereafter mainly described.

Specifically, in the system of this embodiment, a user terminal 20 is enabled to communicate through a network 30 to the license center unit 40. The user terminal holds an SD card SDq conforming to Mqbic that is freely attachable and detachable therein, and a storage medium (here it is an SD card SDa for D audio) not conforming to MQbic but wishing shift to an SD card SDq.

The user terminal 20 is equipped with a memory 21, a download unit 22, an SD card processing unit 23, and a control unit 25. For a user terminal 20, any arbitrary device may be used, if it is an electronic instrument holding an SD card SDq attachable and detachable therein, such as a personal computer, a portable cellular phone, or a portable information terminal (personal digital assistant).

Here, the memory 21 is an area in which the other unit 22-25 may read or write. For example, encrypted content data Enc (Kc, C) may be stored.

The download unit 22 is controlled by the control unit 25, and it has a function of downloading the encrypted content key data Enc (Ku, Kc) and user keys from the license center unit 40. For example, browser software or the like may be used therefor.

The SD card processing unit 23 is controlled by the control unit 25, and comprises an authentication unit 23a, a communication unit 23b, a read/write unit 23c, a encryption/decryption unit 23d, and a key generation unit 23e. The authentication unit 23a performs authentication of the SD card SDq. The communication unit 23b manages the data communication between the SD card SDq and the user terminal 20 and between the user terminal 20 and the license center unit 40. The read/write unit 23c manages the data read and write between the SD card SDq and the user terminal 20 or between the SD card SDq and the license center unit 40. The key generation unit 23e generates the user key data of the like. The control unit 25 has a usual computer function and a function of controlling another unit 21-24 according to an operation of a user.

The license center unit 40 is equipped with a key delivery server 41 and the security module 42.

The key delivery server 41 receives from the user terminal 20 through a network 30 a request of transmitting a content key.

In this case, after experiencing a certain authentication process, the key delivery server 41 has a function of returning to the user terminal 20 through a network 30 new content key data concerning the request.

Moreover, when a user key delivery request is received from the user terminal 20 through the network 30, the key delivery server 41 generates the user key data concerning the request, and returns the user key data or the like via the network 30 to the user terminal 20.

The security module 42 is a unit that performs encryption/decryption processing of the user key Ku and the content key Kc, and is equipped with a management key obtaining unit 43, and a key encryption management unit 44.

The management key obtaining unit 43 holds the management key readable from the key delivery server 41.

The key encryption management unit 44 has a function of receiving a setup of a management key by the key delivery server 41, decoding the encrypted user key for management and the encrypted content key for management respectively, which are received from the key delivery server 41 based on the management key to obtain a user key and a content key, encrypting the content key and basic metadata with the user key, and transmitting to the delivery server 41 the encrypted content key (with basic metadata included therein) obtained and (additional) metadata such as a purchase date or the like.

In this system, a procedure of shifting the content data or the like of the SD Audio card SDa (a sender) to the SD card SDq (a receiver) is explained with reference to FIGS. 2 and 3. FIG. 2 is a flowchart explaining this procedure, and FIG. 3 is a schematic diagram showing the situation of data shift.

First, after connecting the cards SDq and SDa to the user terminal 20, the operation panel of the user terminal 20 (not illustrated) is operated. Then, authentication by the authentication unit 23a starts.

After the authentication is completed, the control unit 25 starts the communication unit 23b, and a read/write unit 23c. Thereby, the encrypted content data Enc (Kt, Ca) of the SD Audio card SDa is read from user data area 4′, and the encrypted title key data Enc (Kmua, Kt) is read from the protection area 3′ into the user terminal 20 (S11).

When this read is completed, data move and copy of the SD Audio card SDa are inhibited until a data shift is completed, in order to prevent unfair multiplication of content data (S12).

The encrypted title key data Enc (Kmua, Kt) is decoded by the medium unique key Kmua of the SD Audio card SDa and the title key Kt is obtained, in the same procedure as explained in FIG. 7.

Next, the title key Kt, which is a key encrypting the content data, is encrypted with another key, and is stored in the user data area 4 of the SD card SDq as a receiver. As a key for that, the key generation unit 23e generates the user key Kua (refer to FIG. 3). The generated user key Kua is transmitted to the SD card SDq, encrypted with the medium unique key Kmuq of the SD card SDq, and saved in the protection area 3 (S13). Note that when the user key Kua is already registered for a certain reason, this step S13 is skipped.

On the other hand, the decrypted title key is encrypted with this generated user key Kua, and is moved and saved in the user data area 4 of the SD card SDq (S14). That is, the title key Kt is used for encrypting content data in the SD card SDq as a receiver, just like in the SD Audio card SDa as a sender.

However, different from in the SD Audio card SDa, the title key Kt is further encrypted in the SD card SDq, by the user key Kua generated in the key generation unit 23e. This user key Kua is also encrypted with the medium unique key Kmuq which is unique to the SD card SDq, and is stored in the protection area 3. That is, the content data C of the SD Audio card SDa as a sender is protected in the SD card SDq as a receiver, by performing encryption double key scheme using the original title key Kt and the newly generated user key Kua.

The content data Enc (Kt, Ca) encrypted with the title key Kt is changed into the save format suitable for the SD card SDq, and is stored in a memory 21 (S15). Instead of storing it in the memory 21, it may be stored in the user data area 4 of the SD card SDq. In this way, the above-described procedure is completed, and the data shift from the SD Audio card SDa to the SD card SDq is completed. Then, the read/write unit 23c deletes the data of the SD Audio card as a sender (S16). Thereby, right of the content data is prevented from being multiplied unfairly.

As mentioned above, although the case where the SD Audio card SDa is shifted to the SD card SDq has been explained, the present invention is not limited to this. It can be generally applied to the case where data stored in a storage medium using a different encryption scheme is shifted to a card using an encryption double key scheme.

For example, as shown in FIG. 4, when shifting the storage medium storing content data of ground-wave digital broadcasting to the SD card SDq, the present invention may be applied. That is, in a CA module for ground-wave digital broadcasting, a work key Kw, a master key Km, and a scramble key Kscr and so forth are used. In this case, the user key Ku for encrypting the scramble key Kscr encrypting the content data C is newly generated. And the scramble key Kscr encrypted with this user key Ku is stored in the user data area 4 of the SD card SDq.

The user key Ku is stored in the protection area 3, after being encrypted with the medium unique key Kmuq of the SD card SDq. This also applies in the ground-based broadcasting of a ground wave digital broadcasting (refer to FIG. 5).

In addition, also when converting storage media of openMG, WMT, SD-bind and so forth, the present invention can be applied.

In any cases, the key generation unit 23e generates the second key data for encrypting the first key data which encrypts the content data C directly. And it can be stored in the SD card SDq under a double key scheme using these two pieces of key data.

Moreover, the present invention is applicable not only to the recording medium using an encryption scheme, but also to shifting a storage medium using no encryption schemes to a storage medium using an encryption double key scheme. For example, the case where the data is recorded in a compact disc without being encrypted, and the data is stored in the SD card SDq, is explained in FIG. 6.

The content data Ci (1, 2, 3 . . . in the compact disc is taken into the SD card processing unit 23. Then, per every content data Ci, in the key generation unit 23e, the title key data Kti as the first key data is generated. The content data Ci is encrypted with this title key data Kti.

This encrypted content data Enc (Kti, Ci) is stored in the memory 21 of the user terminal 20. Furthermore, the user key Kua is generated in the key generation unit 23e. The encrypted key Kti is encrypted using this, and is stored in the user data area 4. The user key data Kua is further encrypted with the medium unique key Kmuq, and is stored in the protection area 3.

This example differs from the above-mentioned example in that two kinds of key data are generated in the key generation unit 23e. However, they are the same concerning the viewpoint that the first key data (in this example, Kti) that encrypts content data is encrypted by the second key data (Kua).

In addition, it is preferable that the title key data Kti is generated by a random number based on a medium identifier of the compact disc, a date of executing the data shift, a counter or the like, to prevent a generation of the same title key.

Note that the process described in each of above-mentioned embodiments can be implemented by a program which can make a computer perform the process. The program can be stored and delivered in a storage medium, such as magnetic disks (a floppy (registered trademark) disk, a hard disk, etc.), an optical disk (CD-ROM, DVD etc.), amagneto-optical disk (MO), and a semiconductor memory.

Furthermore, in the above-described embodiment, a card as a data sender and a card as a data receiver are connected to a user terminal 20 at the same time. However, the present invention is not limited to this. For example, a card as a sender is connected to the user terminal 20 first, and after the data is taken, a card as a receiver is connected to the user terminal 20 instead of the card as a sender. Thereafter, data shift operation can be started.

Moreover, as this storage medium, scheme for storing may be of any type, as long as it is a storage medium enabled to store a program, readable by a computer.

Moreover, operating system (OS) working on a computer based on an indication of the program installed in the computer from the storage medium, database management software, and a middleware such as network software, can implement part of the processes for realizing the embodiments.

Furthermore, the storage medium in the present invention is not limited to the medium that is independent of a computer. It may be a storage medium that downloads the program transmitted by a local area network (LAN) or the Internet, etc., and stores or temporarily stores it.

Moreover, a storage medium is not limited to a single one. When the processes in the embodiments are performed by a plurality of media, the media are included in the storage medium according to the present invention. In addition, the medium configuration cay be any type.

Note that a computer in the present invention is configured to perform each process in the embodiments based on a program stored in a storage medium. It may have any configurations. For example, it may be a single device such as a personal computer, or a system having a plurality of network-connected computers.

Moreover, a computer in the present invention is not limited to a personal computer, but includes an operation-processing device included in a information processing device, and a microcomputer. It includes devices or apparatuses that can realize the function of the present invention by a program.

Note that the present invention is not limited to the above-described embodiments themselves. In a practice phase, their components can be modified and embodied, as long as it does not depart from the spirit thereof. Moreover, merging two or more proper components indicated by the above-mentioned embodiments can form various inventions. For example, some components may be deleted from all the components shown in the embodiments. Furthermore, the components employed in different embodiments may be combined suitably.

### BRIEF DESCRIPTION OF THE DRAWINGS

FIG. 1 is a diagram showing the configuration of the storage-medium processing system concerning the embodiment of the present invention.

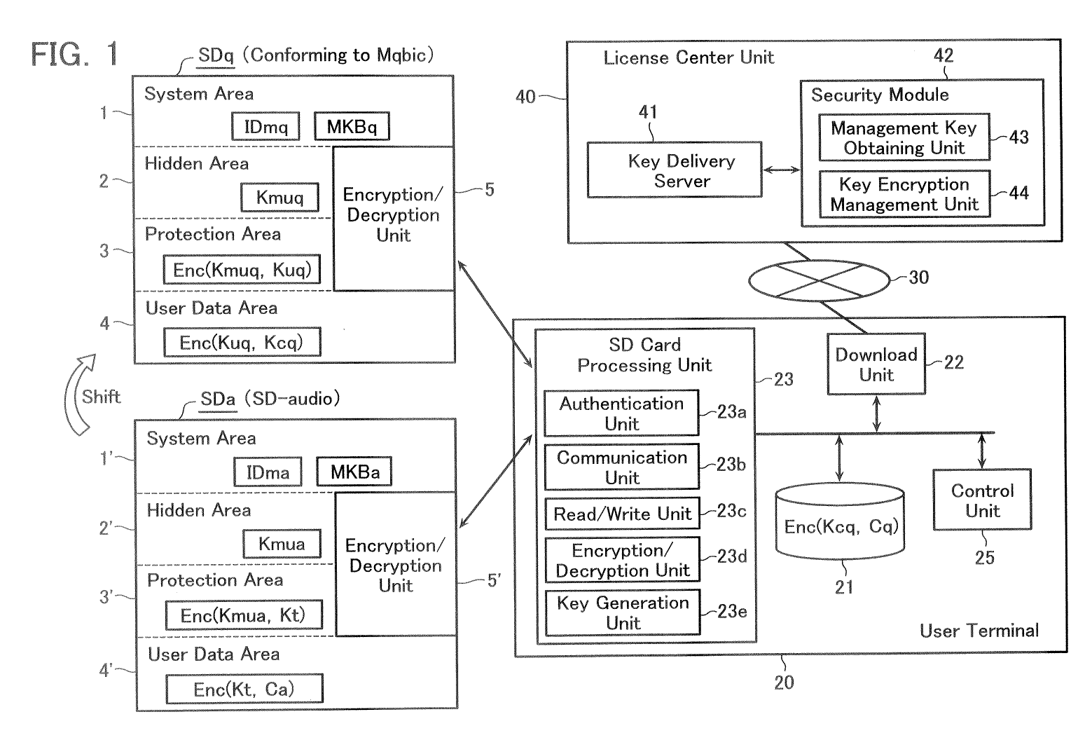

FIG. 2 is a flowchart explaining a procedure of shifting content data or the like of the SD audio card SDa (a sender) to the SD card SDq (a receiver).

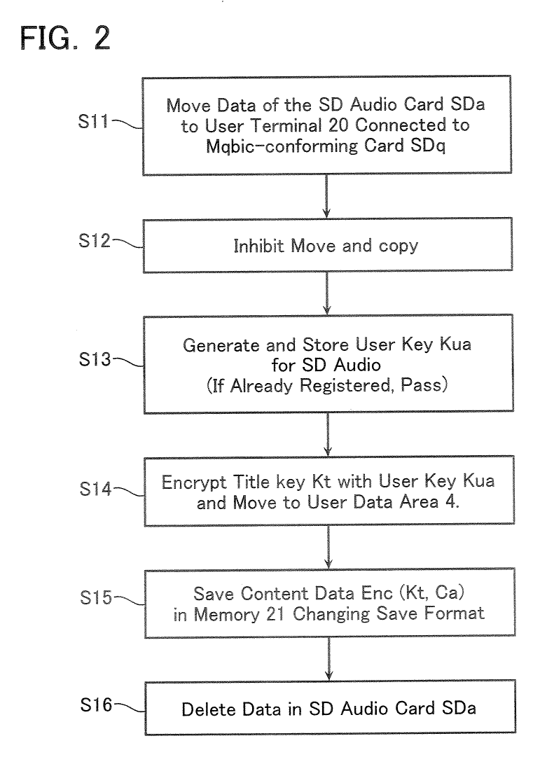

FIG. 3 is a schematic diagram explaining a procedure of shifting content data or the like of the SD audio card SDa (a sender) to the SD card SDq (a receiver).

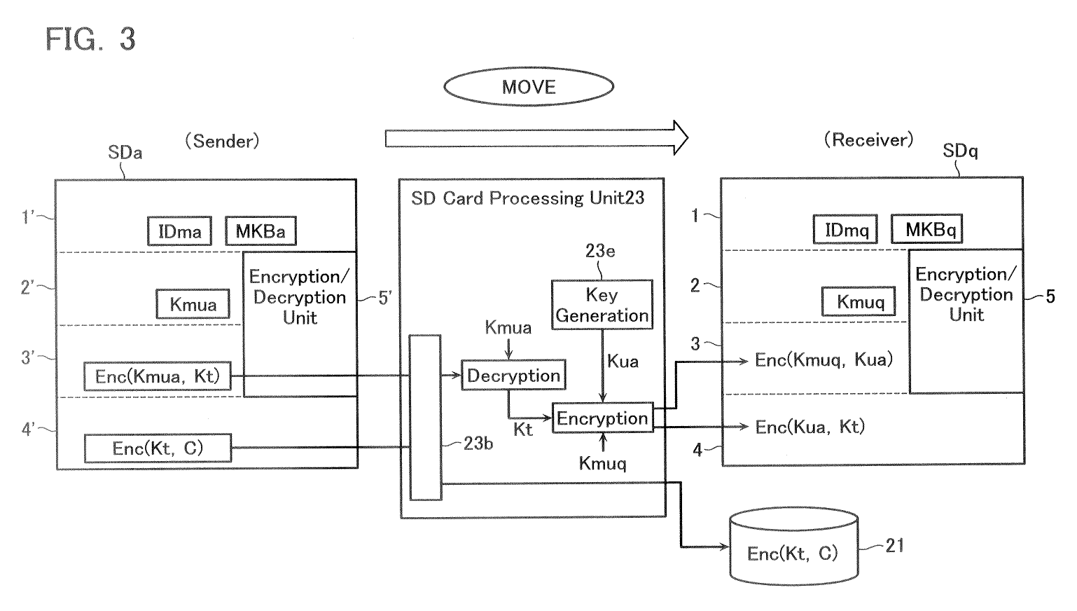

FIG. 4 explains a case where a storage medium storing content data of ground wave digital broadcasting is shifted to a SD card SDq.

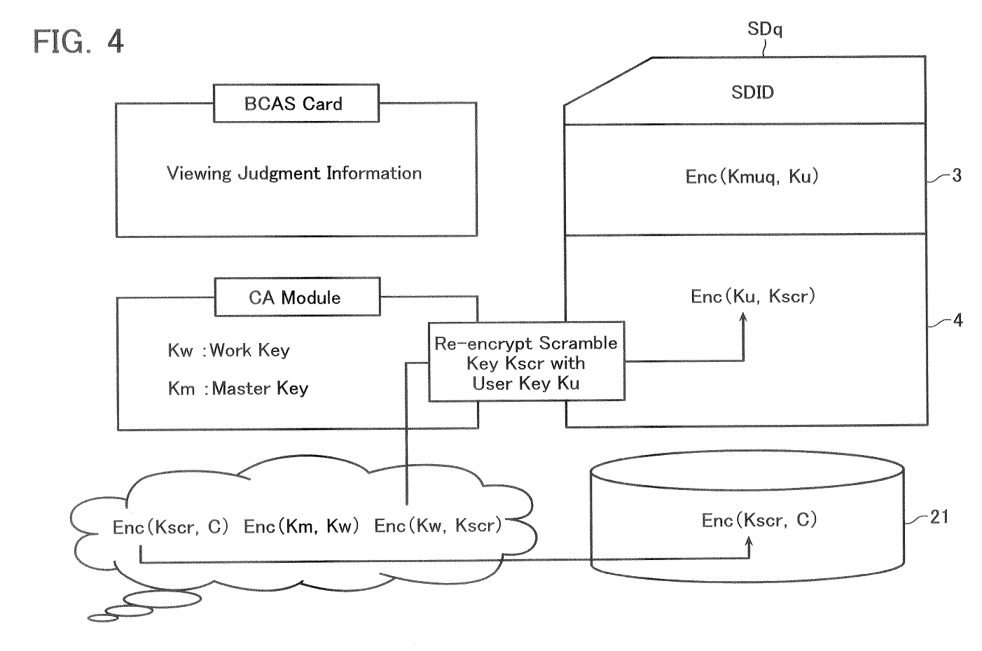

FIG. 5 explains a case where a storage medium storing content data of ground wave digital broadcasting is shifted to a SD card SDq.

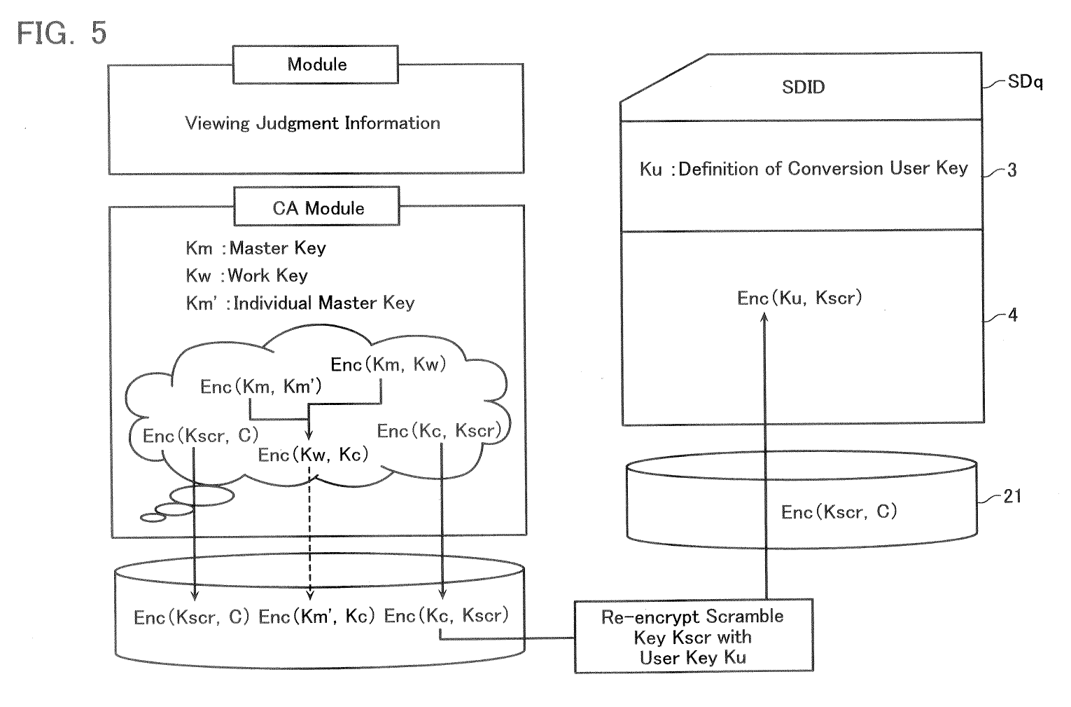

FIG. 6 explains the case where CD's content data is shifted to the SD card SDq.

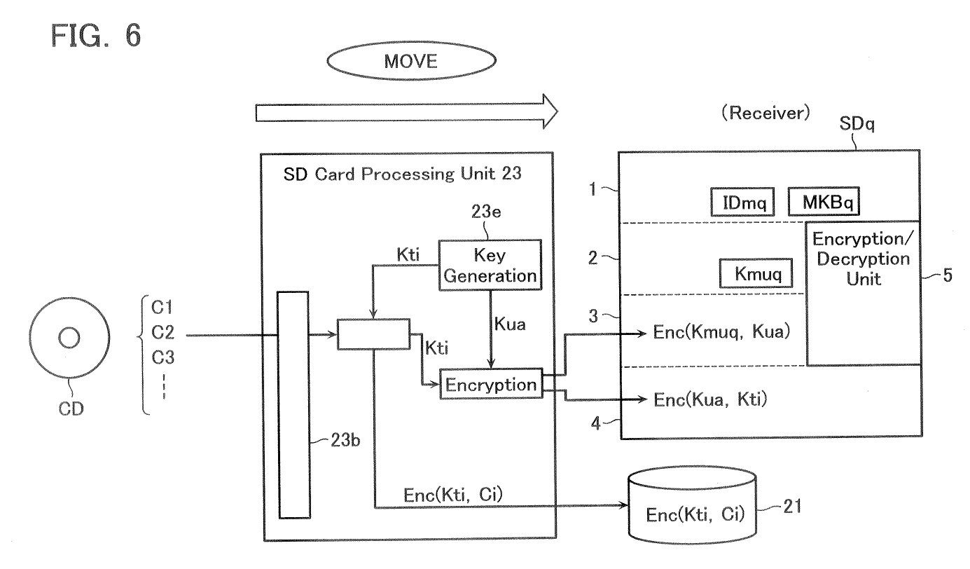

FIG. 7 is a schematic diagram illustrating a configuration of an SD card and a user terminal conforming to a encryption single key scheme.

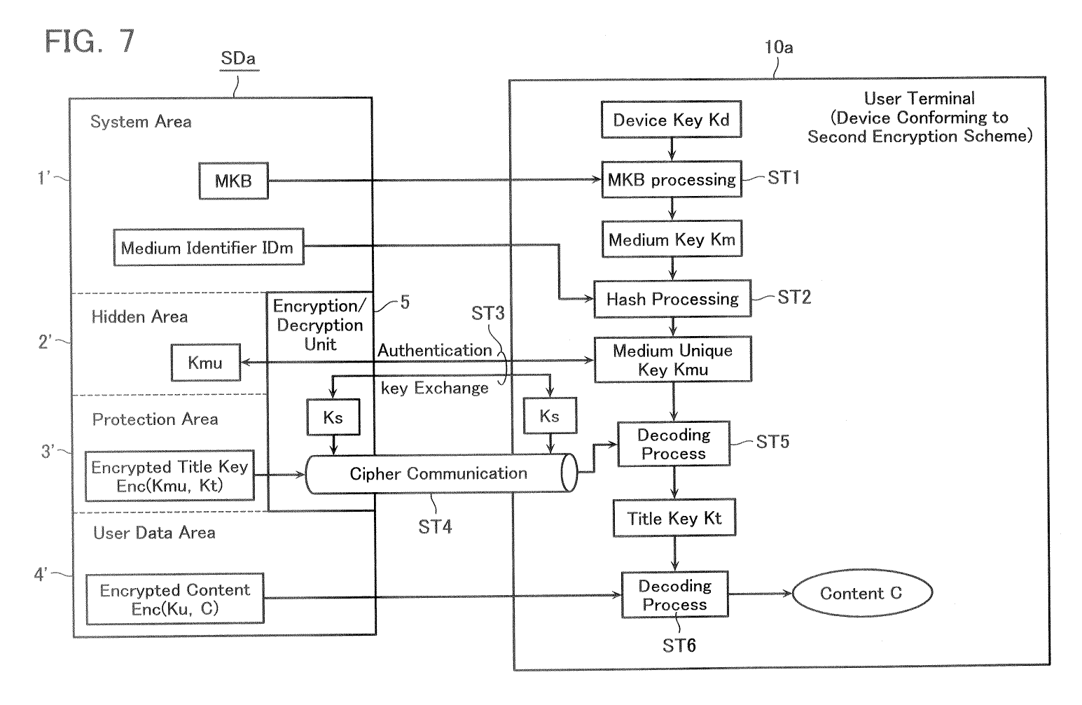

FIG. 8 is a schematic diagram illustrating a configuration of an SD card and a user terminal conforming to a encryption double key scheme.

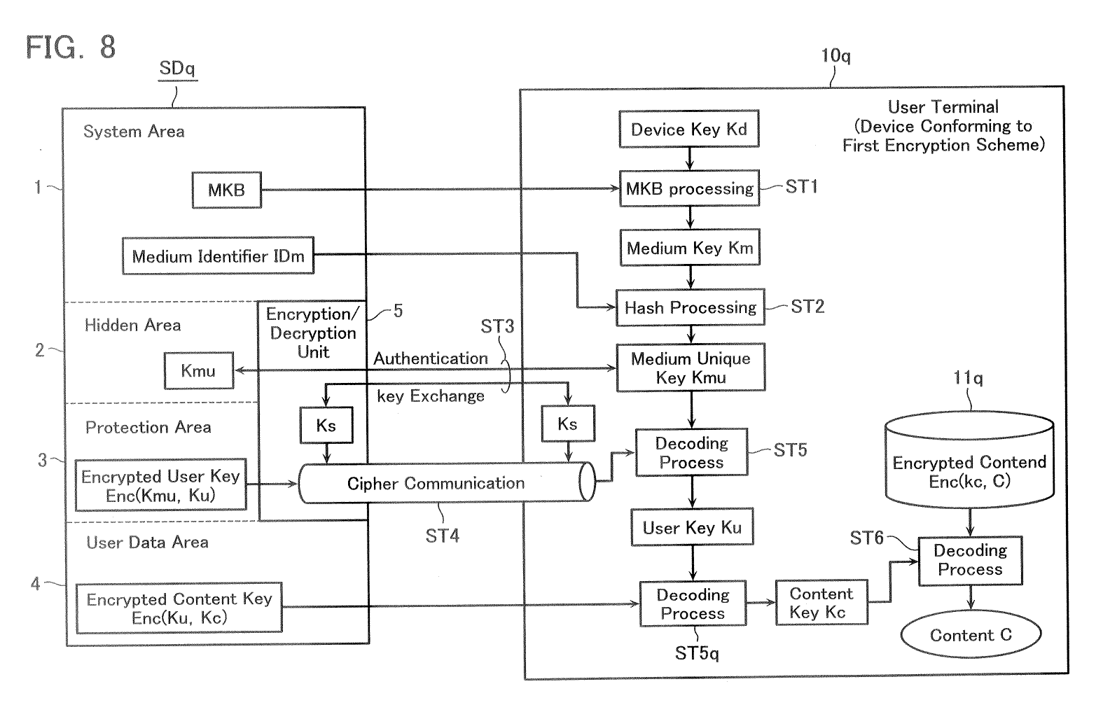

### An Explanation of Symbols

SDq . . . an SD card
1 . . . a system area
2 . . . a hidden area
3 . . . a protection area
4 . . . a user data area,
5 . . . a encryption/decryption unit
20 . . . a user terminal
22 . . . a download unit
23 . . . a SD card processing unit
25 . . . a control unit
40 . . . a license center unit,
41 . . . a key delivery server
42 . . . The security module

1. A content data management method used in a storage medium processing system using a first storage medium and a user terminal, wherein the first storage medium stores medium identifier data, medium unique key data enabled to be generated based on the medium identifier data, encrypted user key data in which user key data is encrypted so that it may be decrypted using the medium unique key data, and first content key data in which content key data is encrypted so that it may be decrypted using the user key data, and the user terminal retains in a memory unit encrypted first content data so that it may be decrypted using the first content key data, thereby the system being configured to protect a right of the first content data by an encryption scheme using the user key and the content key, the method being for commonly utilizing data stored in a second storage medium retaining second content data delivered in a right protection scheme different from that of the first content data,
the method comprising:
a write step writing in the memory unit of the user terminal or the first storage medium the second content data encrypted with first key data;
a step generating second key data for encrypting the first key data; and
a memory step encrypting the first key data with second key data to store it in the first storage medium.

2. A content data management method according to claim 1, wherein transfer and copy of data stored in the second storage medium is inhibited until at least the memory step ends.

3. A content data management method according to claim 1, further comprising a step of erasing data stored in the second storage medium after the memory step ends.

4. A content data management method according to claim 1, wherein the first key data is used in an encryption scheme employed in the second storage medium.

5. A content data management method according to claim 1, wherein the first key data is newly generated in the user terminal for storing content data stored in the second storage medium unencrypted.

6. A content data management method according to claim 1, further comprising a step of encrypting the second key data with the medium unique key in the first storage medium.

7. An electronic device enabled to be connected to a first storage medium storing medium identifier data, medium unique key data enabled to be generated based on the medium identifier data, encrypted user key data in which user key data is encrypted so that it may be decrypted using the medium unique key data, and first content key data in which content key data is encrypted so that it may be decrypted using the user key data, and storing in a memory unit encrypted first content data so that it may be decrypted using the first content key data,
wherein the device is configured to be connected to a second storage medium retaining second content data delivered in a right protection scheme different from that of the first content data, and shift data stored in the second storage medium to the first storage medium, the device comprising:
a key generating unit generating a second key data for encrypting a first key data encrypting the second content data;
an encryption unit encrypting the first key data with the second key data; and
a read/write unit writing the second content data encrypted with the first key data in the memory unit or in the first storage medium, and writing the first key data encrypted in the encryption unit in the first storage medium.

8. An electronic device according to claim 7, further comprising a control unit inhibiting transfer and copy of data stored in the second storage medium until at least the read/write unit ends write operation of the second content data and the first key data.

9. An electronic device according to claim 7, wherein said control unit erases data stored in the second storage medium after the read/write unit ends write operation of the second content data and the first key data.

10. An electronic device according to claim 7, wherein the first key data is used in an encryption scheme employed in the second storage medium.

11. An electronic device according to claim 7, wherein the first key data is generated by the key generating unit for storing content data stored in the second storage medium unencrypted.

12. A content data management program for executing a content data management method used in a storage medium processing system using a first storage medium and a user terminal, wherein the first storage medium stores medium identifier data, medium unique key data enabled to be generated based on the medium identifier data, encrypted user key data in which user key data is encrypted so that it may be decrypted using the medium unique key data, and first content key data in which content key data is encrypted so that it may be decrypted using the user key data, and the user terminal retains in a memory unit encrypted first content data so that it may be decrypted using the first content key data, thereby the system being configured to protect a right of the first content data by an encryption scheme using the user key and the content key, the method being for commonly utilizing data stored in a second storage medium retaining second content data delivered in a right protection scheme different from that of the first content data,
the program being configured to perform:
a write step writing in the memory unit of the user terminal or the first storage medium the second content data encrypted with first key data;
a step generating second key data for encrypting the first key data; and
a memory step encrypting the first key data with second key data to storing it in the first storage medium.
